(19) United States
(12) Patent Application Publication
(10) Pub. No.: US 2023/0353564 A1
(43) Pub. Date: Nov. 2, 2023

(54) MUTUALLY AUTHENTICATED COMMUNICATION WITH REMOTE SIP DEVICE

(71) Applicant: MICROSOFT TECHNOLOGY LICENSING, LLC, Redmond, WA (US)

(72) Inventors: Alex John HOCKEY, London (GB); Mark Lawrence THEBRIDGE, London (GB)

(21) Appl. No.: 17/852,317

(22) Filed: Jun. 28, 2022

(30) Foreign Application Priority Data
Apr. 28, 2022 (GB) 2206157.6

(51) Int. Cl. H04L 9/40; H04L 65/1104; H04L 61/3015

(52) U.S. Cl. CPC H04L 63/0869; H04L 65/1104; H04L 61/3025; H04L 63/0823

(57) ABSTRACT

Using a service mesh in a cluster of a communications network to carry out mutual authentication between a session initiation protocol SIP compliant application in the cluster and a SIP device external to the cluster is described. The mutual authentication is accomplished using a certificate of the application that matches a naming system name used for the application. In response to the mutual authentication succeeding, a secure communication session is established between the application and the SIP device external to the cluster. The method comprises modifying SIP messages originating from the application to indicate that a secure communications protocol is in use. The modified SIP message are sent to the SIP device external to the cluster over the secure communication session.

### CROSS-REFERENCE TO RELATED APPLICATION(S)

This non-provisional utility application claims priority to GB patent application number 2206157.6 entitled “MUTUALLY AUTHENTICATED COMMUNICATION WITH REMOTE SIP DEVICE” and filed on Apr. 28, 2022, which is incorporated herein in its entirety by reference.

### BACKGROUND

Cloud technology serves as a potential solution to meet the demands of application providers seeking to outsource the management of hardware resources such as telecommunications hardware resources. However, considering the resources available through cloud services are used by multiple parties, cloud technology is typically not sufficient to meet the significant security and/or reliability requirements of handling application requests such as telephony application requests. Therefore, there is a need for telephony applications deployed using cloud technology which are able to provide high levels of reliability and/or security.

Where a telephony service or application is deployed in the cloud the functionality of the service is typically provided using a plurality of clusters, each cluster comprising one or more compute nodes where functionality providing at least part of the service or application is installed. By using clusters it is possible to gain geographical redundancy, operational isolation and geographical data residency requirements. However, it can be difficult to enable trusted communication between an application in a cluster and a remote session initiation protocol (SIP) device.

The embodiments described below are not limited to implementations which solve any or all of the disadvantages of known communication using session initiation protocol.

### SUMMARY

The following presents a simplified summary of the disclosure in order to provide a basic understanding to the reader. This summary is not intended to identify key features or essential features of the claimed subject matter nor is it intended to be used to limit the scope of the claimed subject matter. Its sole purpose is to present a selection of concepts disclosed herein in a simplified form as a prelude to the more detailed description that is presented later.

In various examples there is a method comprising using a service mesh in a cluster of a communications network to carry out mutual authentication between a session initiation protocol SIP compliant application in the cluster and a SIP device external to the cluster. The mutual authentication is accomplished using a certificate of the application that matches a naming system name used for the application. In response to the mutual authentication succeeding, a secure communication session is established between the application and the SIP device external to the cluster. The method comprises modifying SIP messages originating from the application to indicate that a secure communications protocol is in use. The modified SIP message are sent to the SIP device external to the cluster over the secure communication session.

Many of the attendant features will be more readily appreciated as the same becomes better understood by reference to the following detailed description considered in connection with the accompanying drawings.

### DESCRIPTION OF THE DRAWINGS

The present description will be better understood from the following detailed description read in light of the accompanying drawings, wherein:

FIG. 1 shows a communications network containing a plurality of clusters for deploying an application in a secure manner;

FIG. 2 is a schematic diagram of a clusters of the communications network of FIG. 1 and a remote SIP device;

FIG. 3 is a flow diagram of a method of operation performed by the cluster of FIG. 2 or FIG. 1;

FIG. 4 is a flow diagram of a method performed by a SIP device;

FIG. 5 illustrates an exemplary computing-based device in which embodiments of a cluster are implemented.

Like reference numerals are used to designate like parts in the accompanying drawings.

### DETAILED DESCRIPTION

The detailed description provided below in connection with the appended drawings is intended as a description of the present examples and is not intended to represent the only forms in which the present examples are constructed or utilized. The description sets forth the functions of the examples and the sequence of operations for constructing and operating the examples. However, the same or equivalent functions and sequences may be accomplished by different examples.

As explained above, an application may be deployed in the cloud the using a plurality of clusters, each cluster comprising one or more compute nodes where functionality providing at least part of the application is installed. By using clusters it is possible to gain geographical redundancy, operational isolation and geographical data residency requirements. However, it can be difficult to enable trusted communication between an application in a cluster and a remote session initiation protocol (SIP) device, that is, a SIP device that is external to the cluster. A SIP device is any node of a communications network which is able to communicate using the session initiation protocol. The external SIP device is independent of the cluster; that is, the external SIP device may have been deployed by another party which is untrusted and/or may be running code which is untrusted. The application is able to communicate using SIP. However, the application does not support a mutually authenticated communications protocol such as mutual transport layer security (mTLS) directly. The application requires to securely talk to an external remote SIP device using a communications protocol with mutual authentication such as mTLS.

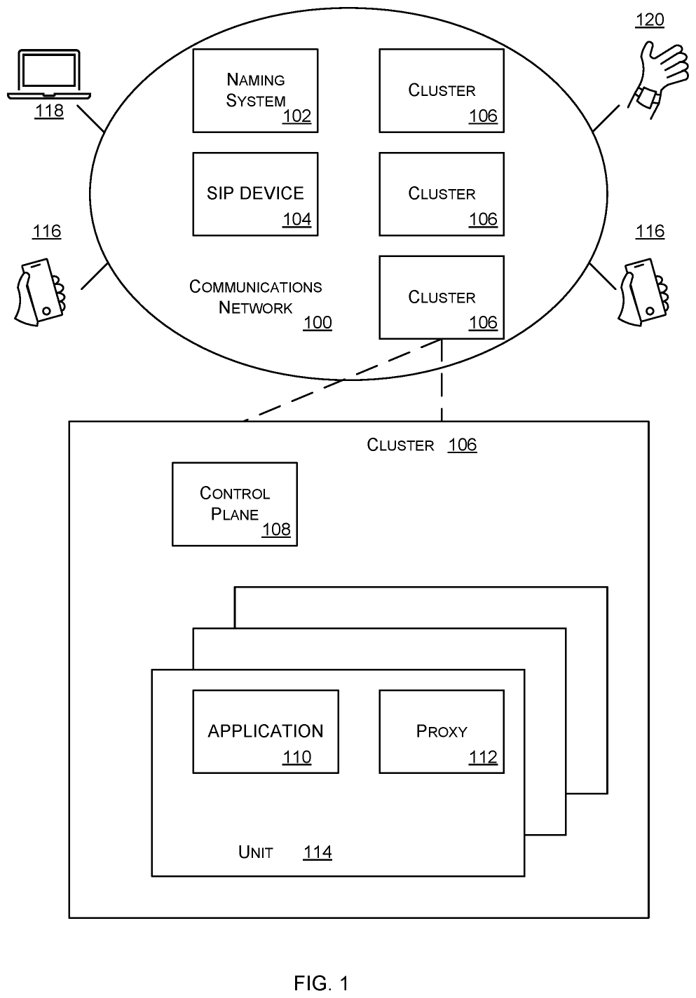

FIG. 1 shows a communications network 100 containing a plurality of clusters 106 for providing one or more applications as services in a secure manner. A subscriber to an application, using a smart phone 116, laptop computer 118, smart watch 120 or other end user device is able to access the application via the communications network 100. In an example, the application is a telephony service such as a mobile voice mail service. Other examples of applications are: any voice over internet protocol service, video call/conferencing, short message service SMS, instant message IM, presence service such as available, busy, away notifications. In some cases there is no subscriber or other end user device. In some cases session initiation protocol flow from the cluster to the SIP device is initiated without user action, such as where there is a timer expiry that initiates a reminder call.

The communications network comprises a naming system 102 such as a domain name system as well as a session initiation protocol device 104 such as a session border controller, router, load balancer or any other communications network node which is SIP compliant. In some examples, an application at one of the clusters 106 generates a message to be sent to the SIP device 104. In some examples, the SIP device 104 generates a message to be sent to one of the clusters. However, sending a message between the cluster and the SIP device 104 is not straightforward to achieve in a secure manner since the SIP device is outside the cluster 106.

FIG. 1 shows three clusters 106 although in practice there are many tens or hundreds of clusters. FIG. 1 shows an exploded view of one of the clusters 106 comprising a plurality of units 114. The units are smallest deployable units of an application used to provide a telephony service or other service. In an example the units are Kubernetes (trade mark) pods where the clusters are orchestrated using Kubernetes (trade mark). However, it is not essential to orchestrate the clusters using Kubernetes (trade mark) as any orchestrator may be used including but not limited to: Docker Swarm (trade mark), Nomad (trade mark), Redhat OpenShift (trade mark), Amazon Elastic Container Service (trade mark).

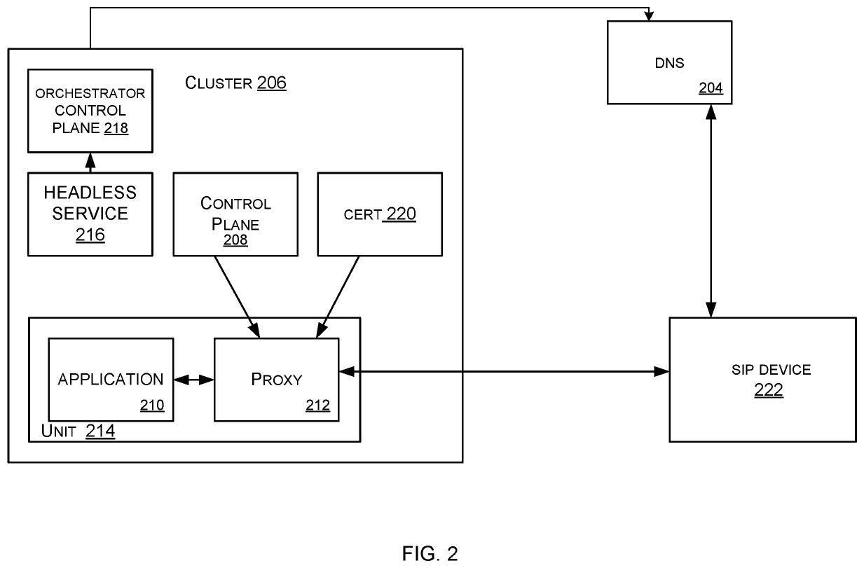

FIG. 1 shows three units 114 although in practice there are hundreds or thousands of units 114 in a cluster 106. An individual cluster has many more components which are not illustrated in FIG. 1 for clarity. More detail about clusters 106 is given with reference to FIG. 2.

Where the application deployed using the clusters 106 is to be secure, security is achieved within each cluster by using a service mesh within each cluster 106. A service mesh in a cluster 106 comprises a control plane 108 and a plurality of proxies, one in each of the units 114; that is, each unit comprises a proxy 112 and a smallest deployable unit of the application 110.

As explained above it can be difficult to enable trusted communication of SIP messages between an application in a unit 114 of a cluster and a remote SIP device 104 outside the cluster. Trusted communication of traffic means sending encrypted traffic over a session between parties where the parties have mutually authenticated one another. In some cases trusted communication also includes mutual authorization of the parties to the session however mutual authorization is not essential.

When deploying services in a zero trust manner it is desired to encrypt network communications between machines (such as the machines on which the units 114 and clusters 106 are executing), and ensure that units 114 authenticate and optionally authorize the other units 114 they talk to. For transport control protocol (TCP) connections within a cluster 106 (such as between units 114) this may be done using mutual transport layer security (mTLS).

In order to ensure that a secure communications protocol with mutual authentication is used within a cluster 106 it is possible to use a service mesh. The service mesh is installed in the cluster, and automatically performs encryption, authentication and optionally authorization. This is achieved by installing a sidecar proxy 112 (which is optionally a container) into every unit 114, along with network routing rules to redirect traffic via the proxy 112. There is also a control plane 108 that runs inside the cluster 106. It programs the proxies 112 with rules to handle traffic and enforce security policy.

The inventors have recognized that where the application does not support a secure communications protocol with mutual authentication it is difficult to enable the application to talk to an external remote SIP device in a secure manner with mutual authentication. Mutual authentication is particularly useful in the case of an external remote SIP device since the external remote SIP device may be controlled by a third party.

The inventors have recognized that if a service mesh is used within a cluster in order to give secure, mutually authenticated communications between entities in the cluster, there are various problems which arise making it difficult to communicate with an external SIP device in a secure, mutually authenticated manner. Three such problems are now explained.

Traffic entering a service mesh would normally pass through an ingress gateway. However, ingress gateways do not normally understand SIP, which means the gateway is not able to load balance effectively, and the remote SIP device cannot load balance either because the gateway hides the application from the remote device. Furthermore, the remote device may expect to use SIP OPTIONS polls to health check the application's endpoints, which the gateway prevents. In various examples of the present disclosure, use of a gateway is not needed so avoiding the problems of an ingress gateway.

A second problem is that as SIP normally uses DNS for endpoint discovery, the remote SIP device may expect that the application presents a certificate that includes the application's DNS name. Service meshes typically do not use certificates in that format. In various examples of the present disclosure, a certificate of the application is used which matches a domain name system name used for the application by the remote SIP device.

A third problem is that if a service mesh is used to ensure messages are in a secure, mutually authenticated protocol, this can introduce inconsistencies leading to messages which are no longer SIP compliant and which therefore fail leading malfunction of the application. In various examples of the present disclosure, SIP messages originating from the application in the cluster are modified to say that a protocol with mutual authentication is in use. In this way inconsistency is avoided.

Various embodiments seek to mitigate one or more of these problems by using a service mesh in a cluster of a communications network to carry out mutual authentication between a session initiation protocol SIP compliant application in the cluster and a SIP device external to the cluster. The mutual authentication is accomplished using a certificate of the application that matches a naming system name used for the application. In response to the mutual authentication succeeding, a secure communication session is established between the application and the SIP device external to the cluster. The method comprises modifying SIP messages originating from the application to indicate that a secure communications protocol is in use. The modified SIP message are sent to the SIP device external to the cluster over the secure communication session.

FIG. 2 is a schematic diagram of a cluster 206 of the communications network of FIG. 1. The cluster 206 is an example of one of the clusters 106 of FIG. 1 and shows more details. The cluster 206 has a plurality of units 214 although only one is shown in FIG. 2 for clarity. In examples there are hundreds or thousands of units 214. Each unit is a smallest deployable unit and is an example of one of the units 114 of FIG. 1. Each unit comprises an application 210 and a proxy 212. Within a unit 214 the application is able to communicate with the proxy 212 but is unable to use transport layer security TLS.

FIG. 2 shows a control plane 208 in cluster 206. Each cluster has a control plane 208 as illustrated at 108 in FIG. 1. The control plane 208 is part of a service mesh formed by control plane 208 and each of the proxies 212 in the units 214. That is, each cluster 206 has a service mesh comprising a control plane 208 and at least one proxy 212 in a unit 214.

In the example of FIG. 2 the cluster 206 has an orchestrator control plane 218 and a headless service 216 which are both optional components.

The cluster 206 is able to access a naming system 102 such as that illustrated in FIG. 1 and in the example of FIG. 2 the naming system is a domain name system 204. The naming system 102 is also accessible by the remote SIP device 222 as illustrated in both FIGS. 1 and 2.

Preferably, the addresses of the units of a cluster 106, 206 are directly routable from the remote SIP device and vice versa. This may be achieved using virtual networking provided by the cloud or other virtualization infrastructure. However, it is not essential for the addresses to be directly routable because it is possible to use indirect routing such as via a firewall, router, network address translator NAT or other intermediate network node.

Within the naming system 204 there are entries for the application 210, that the remote SIP device 222 can access. The entries are made manually or using an automated process. In one example, this is achieved by configuring a headless service 216. The headless service 216 automatically creates naming system records that refer to the individual unit 214 addresses in association with a domain name of a service provided by the application. The naming system records are sent from the headless service 216 to populate the naming service via the orchestrator control plane in some cases. The naming system is arranged so that the remote SIP device 222 can query the records for the units 214 (e.g. using naming system delegation). Another option is to use dynamic domain name system DNS to populate the naming system.

In the example of FIG. 2 the cluster 206 has a certificate 220 which is accessible to the unit 214 and is usable in a mutual authentication process with the SIP device 222 as explained in more detail below. In an example the certificate 220 matches a naming system name used for the application. The certificate is made accessible to the units 214 in the cluster. In one example the certificate is a Kubernetes Secret. If other certificates are needed to enable communication with the remote SIP device 222 these are also made available to the units 214.

As mentioned above, the cluster 106, 206 has a service mesh comprising control plane 208 and one or more proxies 212. This service mesh is arranged so that the proxies use a communications protocol with mutual authentication accomplished using a certificate of the application that matches a naming system name used for the application, when establishing connections to the remote SIP device 222. This can be achieved by one or more of:
a) using capabilities built into the service mesh,
b) using a service mesh that allows control over the proxy config, and using this to remove the service mesh's default config and installing custom config that uses the appropriate certificates;
c) intercepting the proxy config after it is sent by the control plane and modifying the proxy config to use the appropriate certificates before it reaches a proxy.

The application 210 is enhanced to modify SIP messages that it sends to the remote SIP device in order to overcome any inconsistencies which are introduced as a result of uplift of those messages to a mutually authenticated protocol by the proxy. Where the application is using an unencrypted transport protocol as part of the protocol stack supporting its SIP messages, the application is arranged to modify its SIP messages to say that a secure transport protocol is being used in its protocol stack even though that is not actually the case. In one example, where the application uses unencrypted TCP transport as part of the protocol stack, the SIP messages of the application are modified to say that TLS is being used even though TCP is in fact being used. In an example, the application is arranged to modify all SIP messages it generates to indicate TLS is being used. In another example, the application comprises one or more rules which modify SIP messages generated by the application only when a service mesh comprising control plane 208 is detected in the cluster 206.

In an example, the application is able to communicate with the proxy using SIP over TCP and the SIP messages are modified to say that TLS is being used even though it is not actually being used. The proxy sends the modified SIP messages to the remote SIP device over a mutually authenticated secure communication session between the proxy and the remote SIP device. When the remote SIP device receives the modified SIP messages it is able to process them successfully as these are indicated as being sent using TLS which is what the remote SIP device is expecting. Without the modification of the SIP messages these would be indicated as having been sent using TCP. In that case the remote SIP device would experience a connection over TLS but SIP messages over that connection which indicate TCP. Therefore, the remote SIP device would detect an inconsistency and drop the packets.

In another example, the SIP device 222 connects to the cluster. In this case, the SIP device 222 looks up a DNS name for the service, connects to a unit 214 in the cluster and expects the unit 214 to present a certificate containing the same DNS name. If the certificate is correctly presented, the SIP device is able to send SIP messages to a proxy in the unit 214. The proxy is configured to take messages received from the SIP device and deliver them to the application.

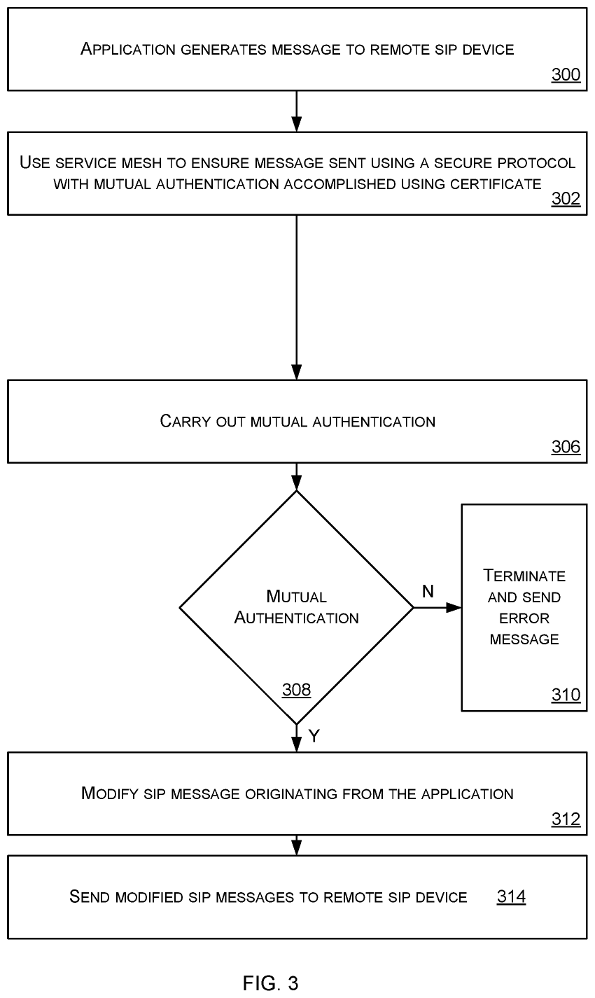

FIG. 3 is a flow diagram of a method of operation performed by the cluster of FIG. 2 or FIG. 1. An application in a unit generates 300 a message to be sent to a remote SIP device 222 (see FIG. 2). A remote SIP device is any SIP device external to the cluster 206. The generated message is a SIP message and may be part of a voice over internet protocol service although that is not essential.

Within the cluster, a service mesh is used 302 to ensure the generated message is sent to the remote SIP device 222 using a secure protocol with mutual authentication. The mutual authentication is accomplished using a certificate 220 of the application 210 that matches a naming system name used by the application 210.

Mutual authentication is carried out 306 between the remote SIP device and the application 210. The mutual authentication process is any known mutual authentication process and involves the application 210 sending, via a proxy 212, a certificate chain comprising the certificate 220. As part of the mutual authentication, the remote SIP device 222 verifies the certificate chain received from the proxy 212 by checking it against a naming system 204 name used for the application 210. The SIP device knows the name of the application through the configuration. As part of the mutual authentication the remote SIP device sends its credentials to the proxy and the proxy verifies those by checking that the certificate presented by the remote SIP device is signed by a root certificate that the proxy trusts and checking that the name in the remote SIP device's certificate matches the name of the remote SIP device in the naming system. This requires the proxy to trust the certificate at the root of the SIP device 222's chain, and the SIP device trusts the certificate at the root of the proxy's chain. This is standard for TLS. Note that the two root certificates may be the same certificate if the same operator manages both the clusters and the SIP device.

If the mutual authentication fails, the process terminates 310 and an error message is sent.

If the mutual authentication succeeds the application 210 modifies 312 the SIP message to be sent by editing the SIP message to say that a secure transport protocol is being used. The application then sends 314 the modified SIP message to the remote SIP device 222.

The process does not require additional gateways to be added. This is useful for reducing overall hardware footprint/cloud spend. But it also means it is possible to handle protocols that cannot be proxied by a service mesh ingress gateway, either because the gateway does not understand the protocol in use (such as session initiation protocol (SIP)) or because the protocol cannot be used with a proxy.

The arrangement of FIGS. 1 and 2 eliminates the need to develop and deploy a SIP-aware ingress gateway. This saves time and costs.

The arrangement of FIGS. 1 and 2 and the method of FIG. 3 does not need any changes to the remote SIP device 222 (which may be outside the control of a deployer of the cluster). Therefore, costs associated with the remote SIP device are constrained and the possibility of introducing errors or security risks in the remote SIP device is avoided.

The arrangement of FIGS. 1 and 2 is simple to setup and operate. It scales well to large numbers of clusters.

The cluster of the disclosure operates in an unconventional manner to enable communication with a SIP device external to the cluster in a secure, mutually authenticated manner, without the need for an additional gateway.

The cluster of the disclosure improves the functioning of the underlying communications network by enabling traffic to be sent between a cluster and a remote SIP device in a secure manner.

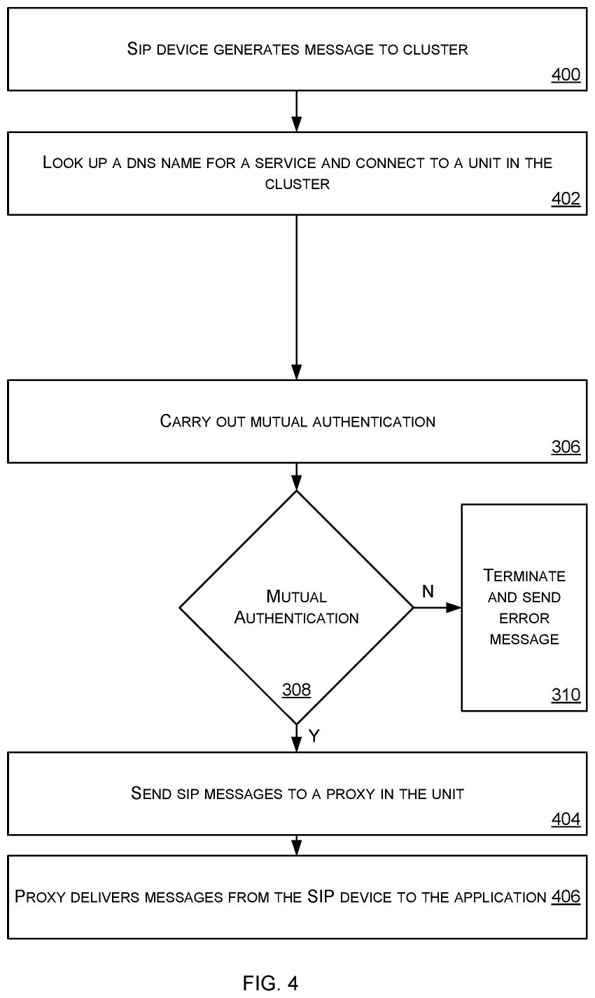

FIG. 4 is a flow diagram of a method of operation at a SIP device such as that of FIG. 1 item 104 and FIG. 2 item 222. The SIP device 222 generates a message to the cluster. In this case, the SIP device 222 looks up 402 a DNS name for a service, and connects to a unit 214 in the cluster. The SIP device carried out mutual authentication 306 as described with reference to FIG. 3 as it expects the unit 214 to present a certificate containing the same DNS name. If the certificate is correctly presented mutual authentication succeeds at check 308 and the SIP device is able to send 404 SIP messages to a proxy in the unit 214. The proxy is configured to take messages received from the SIP device and deliver 406 them to the application. If mutual authentication fails at check 308 the process terminates 310 and an error message is sent.

Alternatively, or in addition, the functionality of one or more of the clusters 106, 206 herein is performed, at least in part, by one or more hardware logic components. For example, and without limitation, illustrative types of hardware logic components that are optionally used include Field-programmable Gate Arrays (FPGAs), Application-specific Integrated Circuits (ASICs), Application-specific Standard Products (ASSPs), System-on-a-chip systems (SOCs), Complex Programmable Logic Devices (CPLDs).

In an example using Kubernetes and TLS, a service mesh is installed in a Kubernetes (K8s) cluster. The service mesh is arranged so that SIP messages sent by an application in a unit using TCP are uplifted to mTLS by a proxy before being sent to a SIP device external to the cluster. The mTLS protocol uses a certificate of the application that matches a naming system name used for the application by the remote SIP device. The application modifies the SIP messages to say that TLS is being used as the transport layer when in fact TCP is being used.

The examples described herein are achieved without the need to add mTLS support directly into the application. Adding mTLS support directly into the application is significant effort as it also involves adding support for certificate rotation, revocation, monitoring, etc. which are things service meshes already support. This is particularly undesirable if the application is a legacy application.

The examples described herein are achieved without the need to create and deploy a SIP-aware, containerized ingress gateway. SIP-aware containerized ingress gateways are not known to exist.

The examples described herein are achieved without the need to enhance the remote SIP device 222 to a) accept different certificate formats (that do not include the DNS name of the application) and b) send/receive L7 messages with the “wrong” transport indications. Making such changes to the remote SIP device is undesirable, particularly if the remote device is aiming to be standards compliant, or is a third party device.

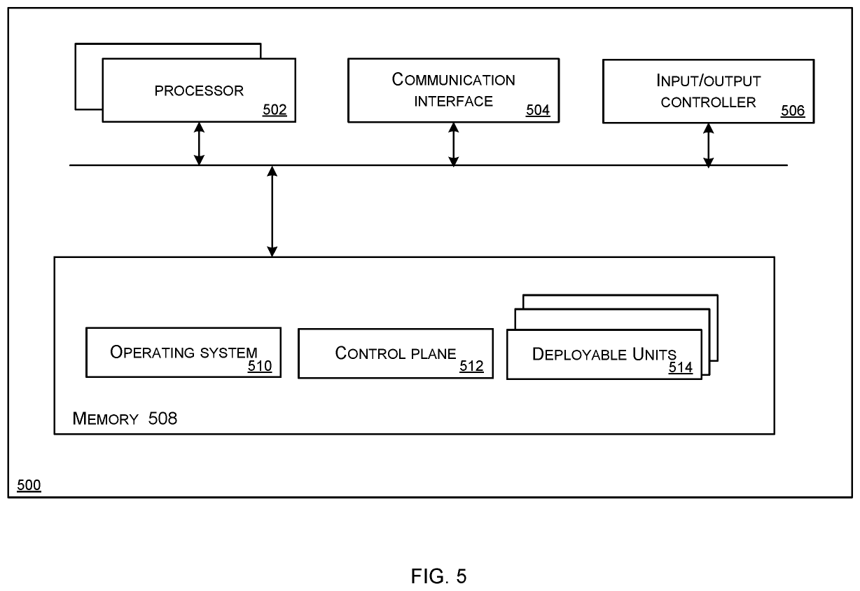

FIG. 5 illustrates an exemplary computing-based device in which embodiments of a cluster are implemented.

Computing-based device 500 comprises one or more processors 502 which are microprocessors, controllers or any other suitable type of processors for processing computer executable instructions to control the operation of the device in order to enable secure, authenticated communication of traffic between a cluster and a SIP device external to the cluster. In some examples, for example where a system on a chip architecture is used, the processors 502 include one or more fixed function blocks (also referred to as accelerators) which implement a part of the method of authenticated communication of traffic between clusters in hardware (rather than software or firmware). Platform software comprising an operating system 510 or any other suitable platform software is provided at the computing-based device to enable application software in deployable units 514 to be executed on the device. A control plane 512 is present.

The computer executable instructions are provided using any computer-readable media that is accessible by computing based device 500. Computer-readable media includes, for example, computer storage media such as memory 508 and communications media. Computer storage media, such as memory 508, includes volatile and non-volatile, removable and non-removable media implemented in any method or technology for storage of information such as computer readable instructions, data structures, program modules or the like. Computer storage media includes, but is not limited to, random access memory (RAM), read only memory (ROM), erasable programmable read only memory (EPROM), electronic erasable programmable read only memory (EEPROM), flash memory or other memory technology, compact disc read only memory (CD-ROM), digital versatile disks (DVD) or other optical storage, magnetic cassettes, magnetic tape, magnetic disk storage or other magnetic storage devices, or any other non-transmission medium that is used to store information for access by a computing device. In contrast, communication media embody computer readable instructions, data structures, program modules, or the like in a modulated data signal, such as a carrier wave, or other transport mechanism. As defined herein, computer storage media does not include communication media. Therefore, a computer storage medium should not be interpreted to be a propagating signal per se. Although the computer storage media (memory 508) is shown within the computing-based device 500 it will be appreciated that the storage is, in some examples, distributed or located remotely and accessed via a network or other communication link (e.g. using communication interface 504).

The computing-based device 500 also comprises an input/output controller 506 arranged to output display information to a display device which may be separate from or integral to the computing-based device 500. The display information may provide a graphical user interface. The input/output controller 506 is also arranged to receive and process input from one or more devices, such as a user input device (e.g. a mouse, keyboard, camera, microphone or other sensor). In an embodiment the display device also acts as the user input device if it is a touch sensitive display device. The input/output controller 506 outputs data to devices other than the display device in some examples, e.g. a locally connected printing device.

Alternatively, or in addition to the other examples described herein, examples include any combination of the following:

Clause A. A method comprising:
using a service mesh in a cluster of a communications network to carry out mutual authentication between a session initiation protocol SIP compliant application in the cluster and a SIP device external to the cluster, the mutual authentication accomplished using a certificate of the application that matches a naming system name used for the application;
in response to the mutual authentication succeeding, establishing a secure communication session between the application and the SIP device external to the cluster;
modifying SIP messages originating from the application to indicate that a secure communications protocol is in use; and
sending the modified SIP message to the SIP device external to the cluster over the secure communication session.

Clause B. The method of clause A wherein using the service mesh to carry out mutual authentication comprises configuring a proxy of the service mesh to use a secure communications protocol with mutual authentication when routing SIP messages to the SIP device.

Clause C. The method of clause B wherein the proxy is configured to receive messages originating from the application, where the application and the proxy are in a deployable unit of the cluster, and where the proxy is configured to take messages received from the SIP device and deliver them to the application.

Clause D. The method of any preceding clause wherein the SIP messages originating from the application use an unencrypted transport protocol prior to the modifying.

Clause E. The method of clause B or clause C or clause D wherein configuring the proxy of the service mesh, is achieved by installing custom configuration and the certificate of the application, or by intercepting a configuration sent by a control plane to the proxy and modifying the configuration before it reaches the proxy and also supplying the certificate of the application to the proxy.

Clause F. A cluster of a communications network the cluster comprising:
a service mesh arranged to carry out mutual authentication between a session initiation protocol SIP compliant application in the cluster and a SIP device external to the cluster, the mutual authentication accomplished using a certificate of the application that matches a naming system name used for the application;
at least one deployable unit of the application, the unit comprising a proxy which is part of the service mesh, the proxy configured to, in response to the mutual authentication succeeding, establish a secure communication session between the application and the SIP device external to the cluster;
the application arranged to modify SIP messages originating from the application to indicate that a secure communications protocol is in use; and
the proxy arranged to send the modified SIP message to the SIP device external to the cluster over the secure communication session.

Clause G. The cluster of clause F wherein the proxy is configured to take messages received from the SIP device and deliver them to the application.

Clause H. The cluster of clause F or G further comprising a headless service which automatically creates naming system records that refer to an address of the unit and other units in the cluster in association with a domain name of a service provided by the application.

Clause I. The cluster of clause H further comprising an orchestrator control plane which sends the naming system records to populate a naming system.

Clause J. The cluster of Clause I comprising virtual networking such that the unit is directly routable from the SIP device and vice versa.

Clause K. A communications network comprising:
at least one cluster;
a session initiation protocol SIP device external to the cluster;
the cluster comprising:
a service mesh arranged to carry out mutual authentication between a SIP compliant application in the cluster and the SIP device, the mutual authentication accomplished using a certificate of the application that matches a naming system name used for the application;
at least one deployable unit of the application, the unit comprising a proxy which is part of the service mesh, the proxy configured to, in response to the mutual authentication succeeding, establish a secure communication session between the application and the SIP device;
the application arranged to modify SIP messages originating from the application to indicate that a secure communications protocol is in use; and
the proxy arranged to send the modified SIP message to the SIP device over the secure communication session.

Clause L. The communications network of clause K comprising a naming system.

Clause M. The communications network of clause L where the cluster comprises a headless service which automatically creates naming system records that refer to an address of the unit and other units in the cluster in association with a domain name of a service provided by the application.

Clause N. The communications network of clause M wherein the cluster comprises an orchestrator control plane configured to send the naming system records to populate the naming system.

Clause O. The communications network of any of clauses K to N wherein the naming system is configured so the SIP device is able to query the naming system to obtain an address of the unit in the cluster.

Clause P. The communications network of any of clauses K to O wherein the application uses an unencrypted transport protocol.

Clause Q. The communications network of any of clauses K to P wherein the secure communications protocol is mutual transport layer security, mTLS.

Clause R. The communications network of any of clauses K to Q wherein the SIP device is directly routable from the unit and vice versa.

Clause S. The communications network of any of clauses K to R comprising a plurality of clusters, each cluster having a plurality of units.

Clause T. The communications network of any of clauses K to S wherein the service mesh comprises a control plane and a plurality of proxies, one in each of a plurality of units.

The term ‘computer’ or ‘computing-based device’ is used herein to refer to any device with processing capability such that it executes instructions. Those skilled in the art will realize that such processing capabilities are incorporated into many different devices and therefore the terms ‘computer’ and ‘computing-based device’ each include personal computers (PCs), servers, mobile telephones (including smart phones), tablet computers, set-top boxes, media players, games consoles, personal digital assistants, wearable computers, and many other devices.

Clause U. A method comprising: performing mutual authentication between a session initiation protocol (SIP) compliant application in a cluster of a communications network and a SIP device external to the cluster, wherein the mutual authentication is performed using a service mesh in the cluster and wherein the mutual authentication is performed using a certificate of the SIP compliant application, the certificate matching a naming system name used for the SIP compliant application;
in response to performing the mutual authentication, establishing a secure communication session between the SIP compliant application and the SIP device;
modifying SIP messages originating from the SIP compliant application to indicate that a secure communications protocol is in use; and
sending the modified SIP message to the SIP device over the secure communication session.

The methods described herein are performed, in some examples, by software in machine readable form on a tangible storage medium e.g. in the form of a computer program comprising computer program code means adapted to perform all the operations of one or more of the methods described herein when the program is run on a computer and where the computer program may be embodied on a computer readable medium. The software is suitable for execution on a parallel processor or a serial processor such that the method operations may be carried out in any suitable order, or simultaneously.

Those skilled in the art will realize that storage devices utilized to store program instructions are optionally distributed across a network. For example, a remote computer is able to store an example of the process described as software. A local or terminal computer is able to access the remote computer and download a part or all of the software to run the program. Alternatively, the local computer may download pieces of the software as needed, or execute some software instructions at the local terminal and some at the remote computer (or computer network). Those skilled in the art will also realize that by utilizing conventional techniques known to those skilled in the art that all, or a portion of the software instructions may be carried out by a dedicated circuit, such as a digital signal processor (DSP), programmable logic array, or the like.

Any range or device value given herein may be extended or altered without losing the effect sought, as will be apparent to the skilled person.

Although the subject matter has been described in language specific to structural features and/or methodological acts, it is to be understood that the subject matter defined in the appended claims is not necessarily limited to the specific features or acts described above. Rather, the specific features and acts described above are disclosed as example forms of implementing the claims.

It will be understood that the benefits and advantages described above may relate to one embodiment or may relate to several embodiments. The embodiments are not limited to those that solve any or all of the stated problems or those that have any or all of the stated benefits and advantages. It will further be understood that reference to ‘an’ item refers to one or more of those items.

The operations of the methods described herein may be carried out in any suitable order, or simultaneously where appropriate. Additionally, individual blocks may be deleted from any of the methods without departing from the scope of the subject matter described herein. Aspects of any of the examples described above may be combined with aspects of any of the other examples described to form further examples without losing the effect sought.

The term ‘comprising’ is used herein to mean including the method blocks or elements identified, but that such blocks or elements do not comprise an exclusive list and a method or apparatus may contain additional blocks or elements.

It will be understood that the above description is given by way of example only and that various modifications may be made by those skilled in the art. The above specification, examples and data provide a complete description of the structure and use of exemplary embodiments. Although various embodiments have been described above with a certain degree of particularity, or with reference to one or more individual embodiments, those skilled in the art could make numerous alterations to the disclosed embodiments without departing from the scope of this specification.

What is claimed is:

1. A method comprising:
performing mutual authentication between a session initiation protocol (SIP) compliant application in a cluster of a communications network and a SIP device external to the cluster, wherein the mutual authentication is performed using a service mesh in the cluster and wherein the mutual authentication is performed using a certificate of the SIP compliant application, the certificate matching a naming system name used for the SIP compliant application;
in response to performing the mutual authentication, establishing a secure communication session between the SIP compliant application and the SIP device;
modifying SIP messages originating from the SIP compliant application to indicate that a secure communications protocol is in use; and
sending the modified SIP message to the SIP device over the secure communication session.

2. The method of claim 1, wherein using the performing mutual authentication comprises configuring a proxy of the service mesh to use a secure communications protocol with mutual authentication when routing SIP messages to the SIP device.

3. The method of claim 2, wherein the proxy is configured to receive messages originating from the application, wherein the application and the proxy are in a deployable unit of the cluster, and wherein the proxy is configured to take messages received from the SIP device and deliver them to the application.

4. The method of claim 1, wherein the SIP messages originating from the application use an unencrypted transport protocol prior to the modifying.

5. The method of claim 2 wherein configuring the proxy of the service mesh, is achieved by installing custom configuration and the certificate of the application, or by intercepting a configuration sent by a control plane to the proxy and modifying the configuration before it reaches the proxy and also supplying the certificate of the application to the proxy.

6. A system running a cluster of a communications network, the system comprising a plurality of computing devices, the cluster comprising:
a service mesh arranged to carry out mutual authentication between a SIP compliant application in the cluster and a SIP device external to the cluster, the mutual authentication accomplished using a certificate of the application that matches a naming system name used for the application;
a deployable unit of the application, the deployable unit comprising a proxy which is part of the service mesh, the proxy configured to, in response to the mutual authentication succeeding, establish a secure communication session between the application and the SIP device external to the cluster;
the application configured to modify SIP messages originating from the application to indicate that a secure communications protocol is in use; and
the proxy configured to send the modified SIP message to the SIP device external to the cluster over the secure communication session.

7. The system of claim 6, wherein the proxy is configured to take messages received from the SIP device and deliver them to the application.

8. The system of claim 6, further comprising a headless service which automatically creates naming system records that refer to an address of the deployable unit and other units in the cluster in association with a domain name of a service provided by the application.

9. The system of claim 8, further comprising an orchestrator control plane which sends the naming system records to populate a naming system.

10. The system of claim 6, wherein the deployable unit is directly routable from the SIP device and vice versa using virtual networking.

11. A communications network comprising a plurality of computing devices, the communications network further comprising:
at least one cluster;
a SIP device external to the cluster;
the cluster comprising:
a service mesh arranged to carry out mutual authentication between a SIP compliant application in the cluster and the SIP device, the mutual authentication accomplished using a certificate of the application that matches a naming system name used for the application;
at least one deployable unit of the application, the unit comprising a proxy which is part of the service mesh, the proxy configured to, in response to the mutual authentication succeeding, establish a secure communication session between the application and the SIP device;
the application arranged to modify SIP messages originating from the application to indicate that a secure communications protocol is in use; and
the proxy arranged to send the modified SIP message to the SIP device over the secure communication session.

12. The communications network of claim 11, further comprising a naming system.

13. The communications network of claim 12, wherein the cluster comprises a headless service configured to automatically create naming system records that refer to an address of the least one deployable unit and other units in the cluster in association with a domain name of a service provided by the application.

14. The communications network of claim 13, wherein the cluster comprises an orchestrator control plane configured to send the naming system records to populate the naming system.

15. The communications network of claim 11, wherein the naming system is operable to enable the SIP device to query the naming system to obtain an address of the unit in the cluster.

16. The communications network of claim 11, wherein the application uses an unencrypted transport protocol.

17. The communications network of claim 11, wherein the secure communications protocol is mutual transport layer security (mTLS).

18. The communications network of claim 11, wherein the SIP device is directly routable from the unit and vice versa.

19. The communications network of claim 11, further comprising a plurality of clusters, each of the plurality of clusters having a plurality of units.

20. The communications network of claim 11, wherein the service mesh comprises a control plane and a proxy in each of the at least one deployable unit.
